(19) United States
(12) Patent Application Publication
(10) Pub. No.: US 2002/0174680 A1
(43) Pub. Date: Nov. 28, 2002

(54) Cryogenic system for producing high purity argon

(76) Inventors: Kenneth Kai Wong, Amherst, NY (US); Dante Patrick Bonaquist, Grand Island, NY (US)

Correspondence Address: PRAXAIR, INC., LAW DEPARTMENT - M1 557, 39 OLD RIDGEBURY ROAD, DANBURY, CT, 06810-5113, US

(21) Appl. No.: 09/861,581

(22) Filed: May 22, 2001

(51) Int. Cl. C01B 23/00; C01B 3/00; B01J 8/00; B01D 47/00; F25J 3/00

(52) U.S. Cl. 62/924; 423/210; 423/262; 62/647

(57) ABSTRACT

A system for purifying and reclaiming argon from an industrial process wherein oxygen is removed by hydrogenation and dehydration, and nitrogen and hydrogen are removed by cryogenic separation.

### TECHNICAL FIELD

This invention relates generally to the production of high purity argon, and is particularly useful for purifying and recycling argon used in the production of silicon crystals or optical fibers.

### BACKGROUND ART

Argon is used as an inerting atmosphere in many industrial processes such as silicon crystal pulling processes and fiber optic production processes. In the course of carrying out such processes the argon becomes contaminated and ultimately must be discarded so that the contaminated inerting atmosphere does not compromise the integrity of the product. Since argon is relatively expensive it would be desirable to have an improved system for recovering the argon from such contaminated inerting atmospheres so that it may be recycled to the production process.

Accordingly it is an object of this invention to provide a system whereby impure argon, such as might be generated from an industrial inerting atmosphere, is effectively purified enabling its reuse in the industrial process.

### SUMMARY OF THE INVENTION

The above and other objects, which will become apparent to those skilled in the art upon a reading of this disclosure, are attained by the present invention, one aspect of which is:

A method for producing high purity argon comprising:

(A) providing gaseous impure argon comprising argon, oxygen and nitrogen, providing a superstoichiometric amount of hydrogen to the gaseous impure argon, and reacting hydrogen with oxygen to produce impure argon comprising argon, nitrogen, hydrogen and water;

(B) removing water from the impure argon to produce dehydrated impure argon comprising argon, nitrogen and hydrogen;

(C) partially condensing the dehydrated impure argon to produce hydrogen vapor and a condensate comprising argon and nitrogen;

(D) passing the condensate as feed into a cryogenic rectification column and separating the feed within the cryogenic rectification column by cryogenic rectification into nitrogen-enriched vapor and argon-enriched fluid; and

(E) recovering argon-enriched fluid as product high purity argon.

Another aspect of the invention is:

Apparatus for producing high purity argon comprising:

(A) a hydrogenator, means for providing gaseous impure argon comprising argon, oxygen and nitrogen to the hydrogenator, and means for providing hydrogen to the hydrogenator;

(B) a dehydration device and means for passing fluid from the hydrogenator to the dehydration device;

(C) a condenser and means for passing fluid from the dehydration device to the condenser;

(D) a cryogenic rectification column and means for passing fluid from the condenser to the cryogenic rectification column; and

(E) means for recovering product high purity argon from the lower portion of the cryogenic rectification column.

As used herein the term “column” means a distillation or fractionation column or zone, i.e. a contacting column or zone, wherein liquid and vapor phases are countercurrently contacted to effect separation of a fluid mixture, as for example, by contacting of the vapor and liquid phases on a series of vertically spaced trays or plates mounted within the column and/or on packing elements such as structured or random packing. For a further discussion of distillation columns, see the Chemical Engineer's Handbook, fifth edition, edited by R. H. Perry and C. H. Chilton, McGraw-Hill Book Company, New York, Section 13, The Continuous Distillation Process.

Vapor and liquid contacting separation processes depend on the difference in vapor pressures for the components. The high vapor pressure (or more volatile or low boiling) component will tend to concentrate in the vapor phase whereas the low vapor pressure (or less volatile or high boiling) component will tend to concentrate in the liquid phase. Distillation is the separation process whereby heating of a liquid mixture can be used to concentrate the more volatile component(s) in the vapor phase and thereby the less volatile component(s) in the liquid phase. Partial condensation is the separation process whereby cooling of a vapor mixture can be used to concentrate the volatile component(s) in the vapor phase and thereby the less volatile component(s) in the liquid phase. Rectification, or continuous distillation, is the separation process that combines successive partial vaporizations and condensations as obtained by a countercurrent treatment of the vapor and liquid phases. The countercurrent contacting of the vapor and liquid phases can be adiabatic or nonadiabatic and can include integral (stagewise) or differential (continuous) contact between the phases. Separation process arrangements that utilize the principles of rectification to separate mixtures are often interchangeably termed rectification columns, distillation columns, or fractionation columns. Cryogenic rectification is a rectification process carried out at least in part at temperatures at or below 150 degrees Kelvin (K).

As used herein the term “indirect heat exchange” means the bringing of two fluids into heat exchange relation without any physical contact or intermixing of the fluids with each other.

As used herein the term “high purity argon” means a fluid having an argon concentration of at least 99 mole percent.

As used herein the terms “upper portion” and “lower portion” mean those sections of a column respectively above and below the mid point of the column.

As used herein the term “superstoichiometric” means an amount of hydrogen greater than the minimum amount needed to completely react with the amount of oxygen present to form water.

As used herein the term “hydrogenator” means a device wherein hydrogen may react with oxygen to form water.

As used herein the term “dehydration device” means a device wherein water in gaseous and/or liquid form is removed from a gas mixture.

### BRIEF DESCRIPTION OF THE DRAWINGS

FIG. 1 is a schematic representation of one preferred embodiment of the high purity argon production system of this invention which is particularly preferred when the oxygen concentration of the contaminated or impure argon is less than about 10 mole percent.

FIG. 2 is a schematic representation of another preferred embodiment of the high purity argon production system of this invention which is particularly preferred when the oxygen concentration of the contaminated or impure argon is greater than about 10 mole percent.

### DETAILED DESCRIPTION

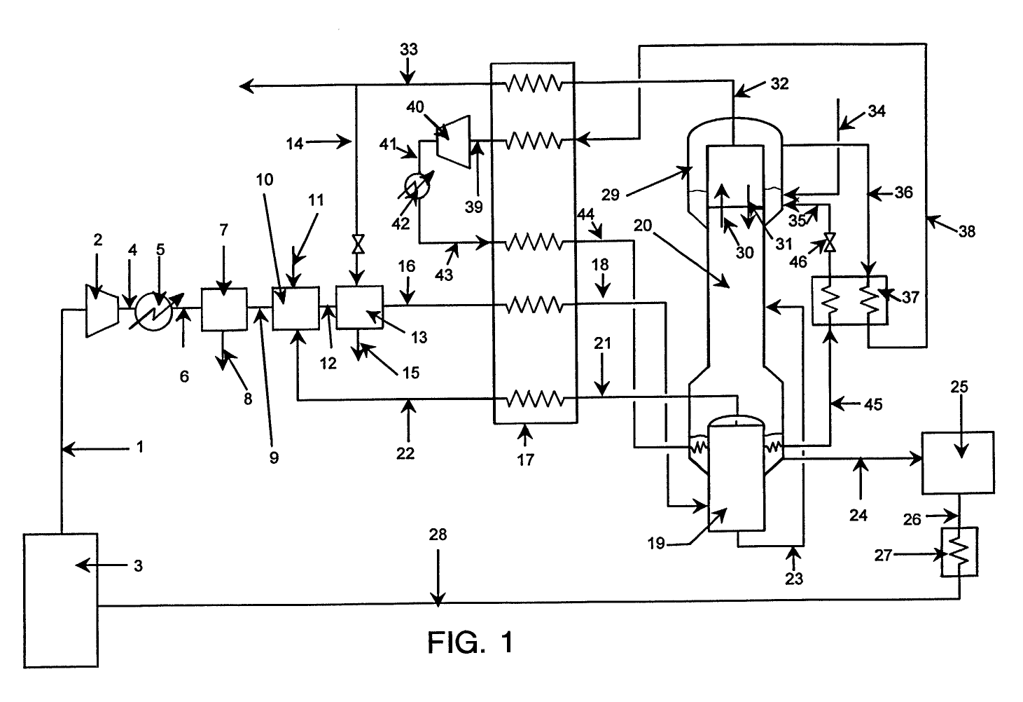

The invention will be described in detail with reference to the Drawings. Referring now to FIG. 1, contaminated argon stream 1 is passed to compressor 2 wherein it is compressed to a pressure generally within the range of from 50 to 100 pounds per square inch absolute (psia). Typically contaminated argon stream 1 is taken from an industrial process or production system 3 such as a silicon crystal pulling process or a fiber optic production system wherein argon is used as an inerting atmosphere. In the course of carrying out the industrial process, contaminants will enter the argon inerting atmosphere necessitating removal of the contaminated argon atmosphere and replacement of the contaminated argon atmosphere with high purity argon. Typically contaminated argon stream 1 will contain argon in a concentration within the range of from 20 to 98 mole percent, oxygen in a concentration up to about 50 mole percent, more typically up to about 20 mole percent, and nitrogen in a concentration up to about 75 mole percent. Other contaminants which may be present in contaminated argon stream 1 include water in a concentration up to about 5 mole percent, carbon dioxide in a concentration up to about 1 mole percent, carbon tetrafluoride in a concentration up to about 10 mole percent, and chlorine in a concentration up to about 10 mole percent.

Referring back now to FIG. 1, compressed contaminated argon stream 4 is cooled of the heat of compression by passage through cooler 5 and resulting stream 6 is passed to adsorbent bed 7 wherein chlorine 8 is removed from the contaminated argon stream. In the event the contaminated argon stream contains no chlorine, the passage to adsorber 7 may be eliminated. Chlorine-free gaseous impure argon in stream 9 is passed to hydrogenator 10. Hydrogen, such as in stream 11, in a superstoichiometric amount is also provided to hydrogenator 10. Typically the hydrogen is provided to hydrogenator 10 in an amount within the range of from 1.2 to 2.5 times the stoichiometric amount. Within hydrogenator 10 hydrogen reacts with the oxygen of the gaseous impure argon to produce water. Resulting impure argon stream 12 is then passed to dehydration device 13, typically an adsorbent system, wherein the water, along with any carbon dioxide and/or carbon tetrafluoride which may be in the impure argon stream, is removed. When dehydration device 13 is an adsorption system such as a molecular sieve adsorption system, it is preferably cleaned of the adsorbed impurities by use of nitrogen sweep gas 14 which is passed out of the adsorption system as contaminant bearing sweep gas 15.

In the embodiment illustrated in FIG. 1, dehydrated impure argon stream 16 comprising argon, nitrogen and hydrogen is cooled by passage through main heat exchanger 17 by indirect heat exchange with return streams and resulting cooled impure argon stream 18 is passed into condenser 19 wherein it is partially condensed by indirect heat exchange with column 20 bottom liquid. The partial condensation of the dehydrated impure argon in condenser 19 produces hydrogen vapor and a condensate comprising argon and nitrogen. Preferably, as illustrated in FIG. 1, the hydrogen vapor is passed from condenser 19 in stream 21, through main heat exchanger 17 and as stream 22 into hydrogenator or hydrogen reactor 10 wherein it serves as additional hydrogen for the requisite superstoichiometric amount of hydrogen provided into hydrogenator or hydrogen reactor 10.

Argon/nitrogen condensate is passed in stream 23 from condenser 19 as feed into cryogenic rectification column 20 which is operating at a pressure generally within the range of from 20 to 70 psia. Within cryogenic rectification column 20 the feed is separated by cryogenic rectification into nitrogen-enriched vapor and argon-enriched fluid which is recovered as product high purity argon from the lower portion of cryogenic rectification column 20. In the embodiment illustrated in FIG. 1, the argon-enriched fluid is passed as liquid stream 24 to storage facility 25 from which it is used as dictated by demand. The high purity argon liquid may be withdrawn from storage facility, e.g. tank, 25 in stream 26, vaporized by passage through vaporizer 27, and then passed in stream 28 to industrial process 3 wherein it serves to replenish the spent inerting atmosphere. In place of or in addition to the arrangement illustrated in FIG. 1, high purity argon vapor may be withdrawn from the lower portion of cryogenic rectification column 20 and passed directly to process or system 3 as the replenishment inerting atmosphere.

Nitrogen-enriched vapor 30 is partially condensed in top condenser 29 by indirect heat exchange with nitrogen liquid as will be further discussed below. The resulting condensed nitrogen-enriched liquid 31 is employed as reflux for column 20. The remaining nitrogen-enriched vapor is withdrawn from top condenser 29 in stream 32, warmed by passage through main heat exchanger 17 and withdrawn from the system in stream 33. If desired, a portion 14 of stream 33 may be employed as the sweep gas in dehydration device 13.

Top condenser 29 is driven by nitrogen liquid from at least one of two sources, makeup nitrogen liquid 34 and heat pump nitrogen liquid 35. The nitrogen liquid vaporizes in top condenser 29 by indirect heat exchange with the partially condensing nitrogen-enriched vapor. The resulting nitrogen vapor is passed out of top condenser 29 in stream 36 and preferably warmed by passage through heat exchanger 37. Resulting nitrogen vapor stream 38 is warmed by passage through main heat exchanger 17. Warmed nitrogen stream 39 is compressed to a pressure within the range of from 50 to 300 psia by passage through compressor 40. Resulting compressed nitrogen vapor stream 41 is cooled of the heat of compression in cooler 42 and resulting stream 43 is cooled by passage through main heat exchanger 17. Resulting cooled nitrogen vapor stream 44 is condensed by indirect heat exchange with argon-enriched fluid thus serving to assist in the reboiling of column 20. As discussed earlier, the partially condensing dehydrated impure argon also serves to provide reboil duty for column 20. Resulting nitrogen liquid 45 is then subcooled by passage through heat exchanger 37, passed through valve 46 and passed as stream 35 into top condenser 29.

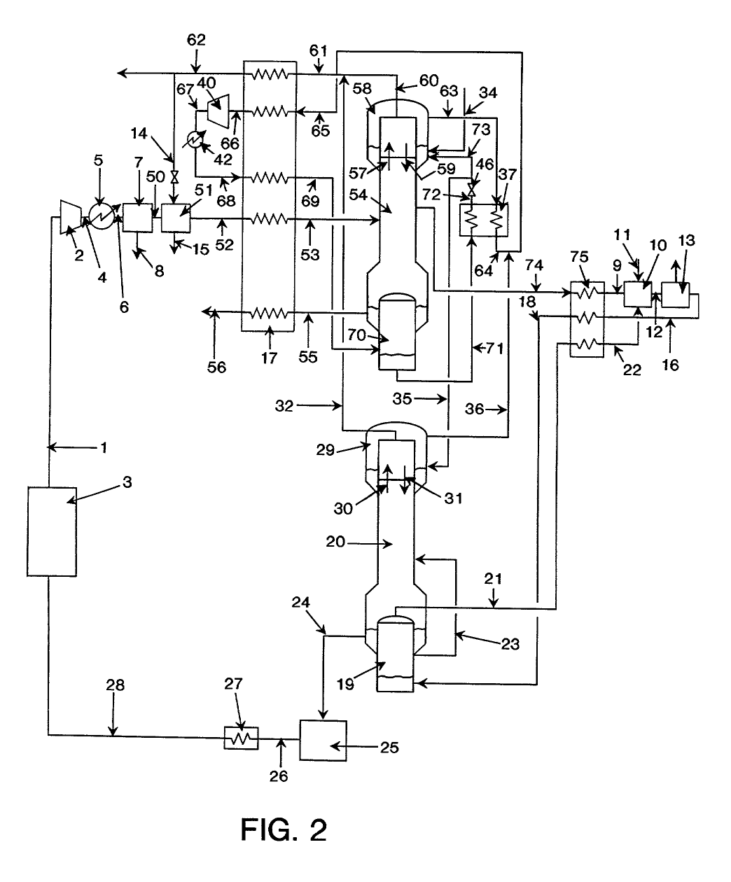

The embodiment of the invention illustrated in FIG. 2 is particularly preferred when the contaminated argon has a relatively high oxygen concentration and uses an additional upstream oxygen separation step. The numerals in FIG. 2 are the same as those of FIG. 1 for the common elements and these common elements will not be discussed again in detail.

Referring now to FIG. 2, the chlorine-free contaminated argon stream is not passed to the hydrogenation unit as in the embodiment illustrated in FIG. 1 but, rather, is passed as stream 50 to purifier 51 wherein it is cleaned of any carbon dioxide, carbon tetrafluoride and/or water that may have been present in contaminated argon stream 1. Resulting stream 52 is cooled by passage through main heat exchanger 17 and then passed in stream 53 as feed into upstream cryogenic rectification column 54 which is operating at a pressure generally within the range of from 15 to 30 psia. Within cryogenic rectification column 54 the feed is separated by cryogenic rectification into nitrogen-richer vapor and oxygen-richer liquid. oxygen richer liquid is withdrawn from the lower portion of column 54 in stream 55, warmed and in some cases at least partially vaporized by passage through main heat exchanger 17, and withdrawn from the system in stream 56 which may be recovered, in whole or in part, as product oxygen having an oxygen concentration within the range of from 98 to 99.99 mole percent.

Nitrogen-richer vapor 57 is partially condensed in top condenser 58 and the resulting liquid 59 is used as reflux for upstream cryogenic rectification column 54. The uncondensed portion is withdrawn from condenser 58 in stream 60 and combined with stream 32 to form stream 61 which is warmed by passage through main heat exchanger 17 and removed from the system as stream 62. As in the embodiment illustrated in FIG. 1, a portion 14 of the nitrogen withdrawal stream may be used as a sweep gas for cleaning purposes. The vaporized nitrogen driving fluid is withdrawn from top condenser 58 in stream 63 warmed by passage through heat exchanger 37, and as stream 64 combined with stream 36 from top condenser 29 to form stream 65 which serves as the heat pump fluid stream. Stream 65 is warmed by passage through main heat exchanger 17 and resulting stream 66 is compressed to a pressure within the range of from 75 to 150 psia by passage through compressor 40. Compressed heat pump fluid stream 67 is cooled of the heat of compression in cooler 42 and passed as stream 68 through main heat exchanger 17 wherein it is cooled to form stream 69. Stream 69 is passed into condenser 70 wherein it is condensed serving to reboil the column 54 bottom liquid. Resulting condensed nitrogen heat pump fluid is passed from condenser 70 in stream 71 to heat exchanger 37 wherein it is subcooled. Subcooled heat pump fluid 72 is passed through valve 46 and a portion of stream 72 is passed into top condenser 29 as stream 35. The remaining portion 73 of the heat pump fluid is passed back into top condenser 58 to help drive the condenser.

Gaseous impure argon comprising argon, oxygen and nitrogen is withdrawn from an intermediate level of upstream cryogenic rectification column 54 in stream 74. Typically the withdrawal level of stream 74 will be from about 15 to 35 equilibrium stages below the top of column 54 where the partial condensation of nitrogen-richer vapor 57 takes place. Impure gaseous argon stream 74 is then warmed by indirect heat exchange with dehydrated impure argon in heat exchanger 75 and then as impure argon stream 9 is passed to hydrogenator 10 and is further processed as was described in conjunction with the embodiment illustrated in FIG. 1 to produce product high purity argon.

Although the invention has been described in detail with reference to certain particularly preferred embodiments, those skilled in the art will recognize that there are other embodiments of the invention within the spirit and the scope of the claims. For example, water and carbon dioxide could be removed by freezing, chlorine could be removed by scrubbing, and carbon tetrafluoride could be removed by thermal or plasma destruction, differential membrane permeation or cryogenic condensation.

1. A method for producing high purity argon comprising:
(A) providing gaseous impure argon comprising argon, oxygen and nitrogen, providing a superstoichiometric amount of hydrogen to the gaseous impure argon, and reacting hydrogen with oxygen to produce impure argon comprising argon, nitrogen, hydrogen and water;
(B) removing water from the impure argon to produce dehydrated impure argon comprising argon, nitrogen and hydrogen;
(C) partially condensing the dehydrated impure argon to produce hydrogen vapor and a condensate comprising argon and nitrogen;
(D) passing the condensate as feed into a cryogenic rectification column and separating the feed within the cryogenic rectification column by cryogenic rectification into nitrogen-enriched vapor and argon-enriched fluid; and
(E) recovering argon-enriched fluid as product high purity argon.

2. The method of claim 1 wherein the hydrogen provided to the gaseous impure argon is in an amount of from 1.2 to 2.5 times stoichiometric.

3. The method of claim 1 further comprising using at least some of the hydrogen vapor produced by the partial condensation of the dehydrated impure argon as part of the superstoichiometric amount of hydrogen provided to the gaseous impure argon.

4. The method of claim 1 wherein the gaseous impure argon is heated by indirect heat exchange with dehydrated impure argon prior to the provision of hydrogen to the gaseous impure argon.

5. The method of claim 1 wherein a contaminated argon stream is cleaned of one or more of chlorine, carbon dioxide and carbon tetrafluoride impurities and is thereafter used to generate the gaseous impure argon.

6. Apparatus for producing high purity argon comprising:
(A) a hydrogenator, means for providing gaseous impure argon comprising argon, oxygen and nitrogen to the hydrogenator, and means for providing hydrogen to the hydrogenator;
(B) a dehydration device and means for passing fluid from the hydrogenator to the dehydration device;
(C) a condenser and means for passing fluid from the dehydration device to the condenser;
(D) a cryogenic rectification column and means for passing fluid from the condenser to the cryogenic rectification column; and
(E) means for recovering product high purity argon from the lower portion of the cryogenic rectification column.

7. The apparatus of claim 6 further comprising means for passing fluid from the condenser to the hydrogenator.

8. The apparatus of claim 6 further comprising means for passing fluid from the upper portion of the cryogenic rectification column to the dehydration device.

9. The apparatus of claim 6 further comprising an upstream cryogenic rectification column, wherein the means for providing gaseous impure argon to the hydrogenator communicates with the upstream cryogenic rectification column.

10. The apparatus of claim 9 wherein the means for providing gaseous impure argon to the hydrogenator includes a heat exchanger, and the means for passing fluid from the dehydration device to the condenser includes said heat exchanger.
